(19) United States
(12) Patent Application Publication
(10) Pub. No.: US 2011/0125511 A1
(43) Pub. Date: May 26, 2011

(54) DEAL GENERATION SYSTEM AND METHOD

(75) Inventor: Reuben Bakst, Brooklyn, NY (US)

(73) Assignee: DEALGEN LLC, Brooklyn, NY (US)

(21) Appl. No.: 12/951,441

(22) Filed: Nov. 22, 2010

Related U.S. Application Data
(60) Provisional application No. 61/281,665, filed on Nov. 21, 2009.

(51) Int. Cl. G06Q 10/00; G06F 3/048

(52) U.S. Cl. 705/1.1; 715/764

(57) ABSTRACT

The present invention generally relates to systems and methods for identifying potentially successful transactions and matching two or more businesses based on a plurality of objective and subjective data points related to each individual business. According to an embodiment of the present invention, the two or more businesses are matched in a manner that maximizes potential success of one or more transactions between the two or more businesses. Transactions may include, but are not limited to, mergers, acquisitions, strategic alliances and joint ventures. One of ordinary skill in the art would appreciate that the system and methods of the present invention could be used to maximize the potential success of any type of transaction, and embodiments of the present invention are contemplated for use with any type of transaction.

### CROSS REFERENCE TO RELATED APPLICATIONS

This application claims the benefit of U.S. Provisional Patent Application No. 61/281,665 Filed Nov. 21, 2009, the entire disclosure of which is incorporated herein by reference.

### FIELD OF THE INVENTION

The present invention generally relates to business to business transactions. More particularly, the invention relates to strategic linking of businesses based on their core potential to form resourceful alliances, promoting growth and development in the industry.

### BACKGROUND OF THE INVENTION

Strategic alliances, of which there are several types, have been viewed as an integral component to the success of any company, big or small, in the global marketplace and the driving force to their growth and development in the global economy. Synergies result in market differentiation, risk and rewards of pursuing particular strategies, leading to beneficial outcomes. However, the current practices for creating synergies and deals between businesses are antiquated. More specifically, the current deal making environment is one that involves a hit or miss strategy with businesses spending many wasteful hours diving into the abyss to find the correct partners in their quest to effectively and efficiently function in the market place and maximize the use of their technology and manpower to generate revenues and achieve dominance in their sectors. In many instances companies themselves do not realize their own growth potential and the advantages of engaging in collaborations with others in the marketplace.

Business entity databases and registries such as Dun & Bradstreet, Inc, Million Dollar Directory, and the Thomas Registry are well known in the art. These databases merely serve as storage houses for business information in the various sectors in the global marketplace, accessible to other businesses and the general public. A concept proposed by Dun & Bradstreet, Inc., as extrapolated in International Application No. PCT/US2004/043754 describes a method for periodically updating a business family tree for changes in branch location and assigning unique corporate identifiers to entities in family trees. However, the concept does not envision facilitating synergies between businesses like the present invention does.

The need to connect businesses and industries with common interests and goals has spawned several innovative concepts. US Pat. Appl. No. 2003/0097271 (now abandoned), describes a method and system for evaluating synergies between multiple organizations and generating a summary of potential synergies accessible by a user. US Pat. Appl. No. 2002/0194018 matches complementary interests of business entities and creates a database of products, services, capital, or technology offered by the companies, or those that they may be interested in acquiring. However, these systems do not actively engage in bringing synergetic companies together using both human and artificial intelligence as the present invention does.

U.S. Pat. No. 7,426,472 discloses a method of connecting businesses through common interests by storing business profiles and attributes in an online business registry that can be searched by an enquiring business with communication links established between the two businesses. However, the method does not use profiling and questionnaires to categorize and store company profiles to arrive at a probabilistic match of the companies that have the highest potential for consummating a deal as the system and method of the present invention does.

Thus, to date, there has been no system in place that generates business development transactions on a large scale. There is also a need in the prior art for a system and method that can actively function to create beneficial and synergistic alliances between companies and businesses through the use of both human and artificial intelligence. The present invention accomplishes that goal through the use of a cadre of dynamic adaptive questionnaires, and the use of its proprietary software and unique system and method of deterministic and probabilistic matching.

The present invention is intended to revolutionize transactions between companies both big and small in the arena of mergers and acquisitions as well as non-mergers and acquisitions transactions. The system and method of the invention has the capability to present millions of companies with transactions on a mass scale and assist with fruitful collaborations between entities.

Another concept unique to the present invention is its ability to use past transaction patterns and historical transactions between companies to determine which companies are capable of consummating transactions based on past transaction-making successes and/or failures.

These and other features and advantages of the present invention will be explained and will become obvious to one skilled in the art through the summary of the invention that follows.

### SUMMARY OF THE INVENTION

The present invention is a mechanism conceived to link businesses in a manner destined to revolutionize and achieve growth and productivity in the global marketplace. The goal of the invention is to identify and pair up businesses that will benefit from their synergistic alliances to achieve their maximum growth potential and productivity.

The embodiments of the invention combine the positive attributes of both human and artificial intelligence and capabilities to bring about collaborations between businesses that will be mutually beneficial. That goal is achieved by the present invention through a process of proactive profiling and automated analysis.

Through its proprietary software, the present invention uses a market modeling and matching system of categorizing companies in a given sector using dimensions such as, products and services; key assets and resources; value activities; customer segments, ways to reach customers etc.

The present invention envisions active involvement in the strategic planning and candidate screening phases of transaction making between businesses. One embodiment of the invention uses a staff of profiling experts to conduct interviews with appropriate personal in the companies to gather data on the businesses by presenting a set of questionnaires. The answers to the questionnaires are then compiled and uploaded into the system of the present invention and analyzed using a unique set of algorithms and matching technologies to propose an initial set of acquisition targets or business development partners for the company.

The questionnaire system crafted by the present invention is an important component of the system's matching capability. The dynamic nature of the questionnaire entails changes to questions based on the answers to other and previous questions since each variable will affect subsequent ones. In addition, the questionnaires will be tailored to the company's assets and its products in the pipeline. Probabilities of a match are determined based on the many variables provided by the company in their answers to the questionnaires using an “importance score/rating” system to figure where each factor stands in relation to the others. Each variable is assigned a score depending on how it interacts with other variables to determine which matches are appropriate and have the potential to consummate a transaction.

In an embodiment of the invention, after the question and answer data from a particular company or business is uploaded into the system of the present invention and analyzed using the unique set of algorithms and matching technologies, the resulting data is compared to data from other companies and the automation software of the present invention, narrows down the range of possible matches from several thousands to hundreds and narrower still to achieve the best possible fit for the particular company with one or more other companies. The system generates a list of companies and neatly organizes them in order of priority defined by transaction attractiveness. After the analysts review the findings and determine which of the listed candidate companies are most attractive from a deal perspective for the transaction seeking company, they present these transaction opportunities directly to the company either through a direct call, email, fax, regular mail or via an interactive mode through the invention's website. In this embodiment of the invention, the system can also recommend distinct business development opportunities for alternative strategies under consideration by a company.

A significant feature of the present invention that maximizes its transaction making capacity lies in the two types of matchmaking systems used in making transaction recommendations for a company. These two matching systems are, deterministic matching and probabilistic matching.

Deterministic matching involves recommending mergers and acquisitions or other business development activity based on detailed input provided by a company. The system of the invention actively solicits transaction related information from companies based on its proprietary categorization scheme which directly matches companies within an industry based upon this input.

Probabilistic matching involves making transaction recommendations based on a transaction strategy that utilizes specific algorithms in evaluating matching candidates for a company within a company data base. For probabilistic matches, the inventions' recommendation engine ranks transactions by likelihood of success and provides a transaction rationale for each business development opportunity.

Another significant feature unique to the present invention as it relates to probabilistic matching is the ability of its unique software to tease out and analyze past transaction patterns, and historical, non-obvious alliances to determine which companies are capable of consummating which transaction. This is in essence true probabilistic matching and artificial intelligence, not purely based on the questionnaires posed, but rather on patterns gleaned from previous and old transaction by the system of the present invention to suggest transaction between companies based on the programmed transaction patterns.

In another embodiment of the present invention, transaction making is accomplished through intermediaries such as investment banks, business brokers and consultants. In that embodiment, leads generated through data analysis by the system are sold to these intermediaries for a small fee charged per lead. In some cases the system of the present invention will choose to mandate a percentage of the success fee should the intermediary successfully broker the transaction. A related embodiment, envisions a network of intermediaries who will be charged with assisting in the facilitation of transaction in exchange for a percentage of transaction value. This will set in place a hierarchy of “vendor managers” and subordinate players in the deal making arena.

The technical systems and tactical methodologies used in the various embodiments of the current invention will enable a multitude of companies to conduct business development transactions that heretofore were not possible. For every one transaction utilizing the current methodology, at least three transaction could be generated using the unique capabilities and resources of the present invention. Strategic exit planning is also another goal of the present invention.

The transaction recommendation engine of the present invention is designed to continuously learn and improve. The system of the invention is based on the following tenets:
Time-sensitive deal strategies—strategies that were effective in the past may not remain viable in the future;
Historical transactions—past transactions from all industries can be useful in building knowledge as to which transactions are likely to succeed (or fail) in the future;
Feedback from companies on recent transactions—an active, aggressive feedback loop that encourages companies to evaluate and communicate about recent transactions they have entered into through the deal recommendations made by the system's analysts and provide current business development strategies and interests.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 depicts an exemplary system model in accordance with an embodiment of the present invention.

FIG. 2 depicts an exemplary method in accordance with an embodiment of the present invention.

### DETAILED SPECIFICATION

The present invention generally relates to systems and methods for identifying potentially successful transactions and matching two or more businesses based on a plurality of objective and subjective data points related to each individual business. According to an embodiment of the present invention, the two or more businesses are matched in a manner that maximizes potential success of one or more transactions between the two or more businesses. Transactions may include, but are not limited to, mergers, acquisitions, strategic alliances and joint ventures. One of ordinary skill in the art would appreciate that the system and methods of the present invention could be used to maximize the potential success of any type of transaction, and embodiments of the present invention are contemplated for use with any type of transaction.

According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

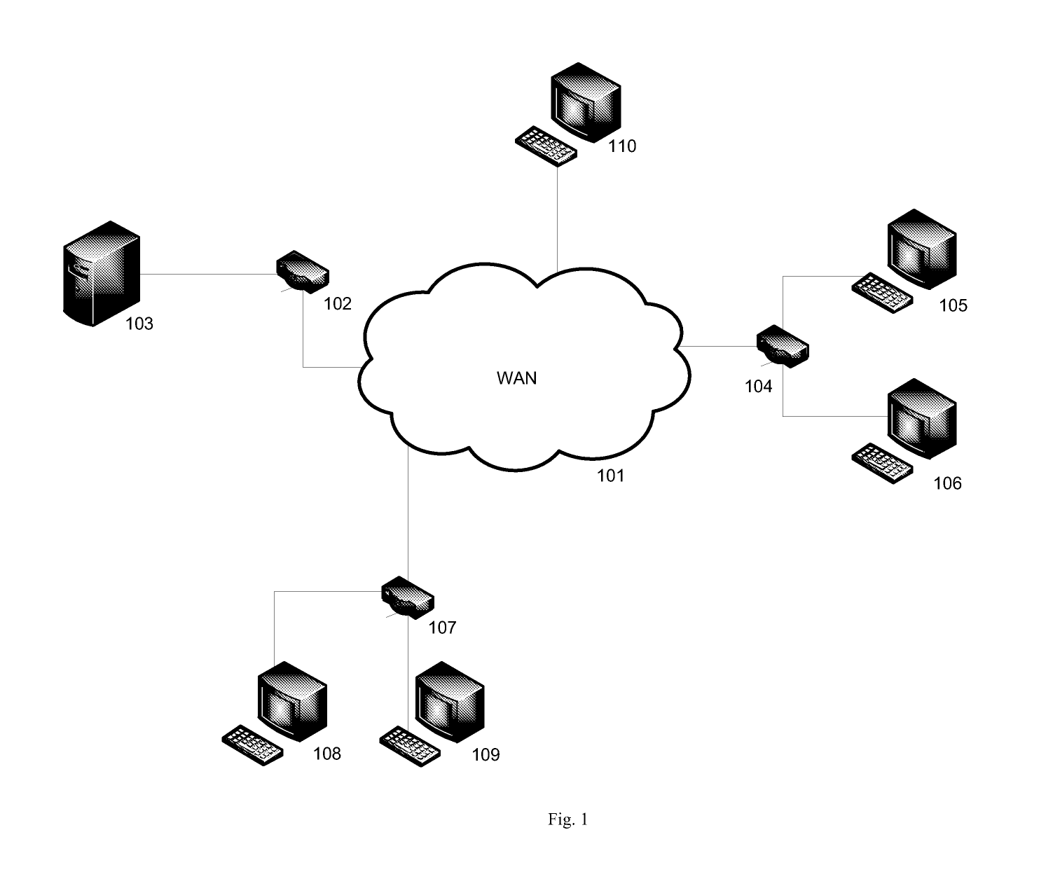

Referring to FIG. 1, according to an embodiment of the present invention, the systems and methods of the present invention may be provided across a WAN 101. In this configuration, data will be communicated across the WAN 101 and received at a network access point 102. Network access point 102 could be comprised, for instance, a network router. Server 103 resides behind network access point 102 and may receive, process and transmit data in accordance with the system and methods provided herein.

In accordance with an embodiment of the present invention, data may be transferred from one or more computing devices 105, 106, 109 and 110 across WAN 101 to server 103. In the example shown in FIG. 1, computing devices 105 and 106 represent computing devices belonging to a first business and are located behind a network access point 104, computing devices 108 and 109 represent computing devices belonging to a second business and are located behind a network access point 107 and computing device 110 represents a computing device belonging to an affiliated third-party (e.g., accountant, attorney, brokerage firm).

Continuing from the example shown in FIG. 1, users of the computing devices 105, 106, 108, 109 may submit data to server 103. The submitted data is comprised of a plurality of individual data points. Each individual data point is comprised of subjective or objective information pertaining to the particular business. Objective information may include, but is not limited to, number of employees, valuation, market cap, debt ratios, shares outstanding and current share price. Subjective information may include, but is not limited to, information related to corporate culture, information related to management style of executive officers and information related to the operating style of the business (e.g., aggressive, cautious, reserved). Subjective information is sometimes referred to as the “soft variables” and may require more work to identify and properly evaluate. Methods of properly identifying and evaluating the “soft variables” are described and detailed below. One of ordinary skill in the art would appreciate that there are numerous objective and subjective data points that could be used with embodiments of the present invention, and embodiments of the present invention are contemplated for use with any objective and subjective data points.

According to an embodiment of the present invention, an affiliated third-party may be allowed to submit data to server 103 via computing device 110. The data submitted by an affiliated third-party may be limited to only objective data, only subjective data or any combination thereof. For example, a business may desire to have their accountant submit financial data points to server 103 to provide a more robust picture of the business as represented in the data as a whole.

FIG. 1 is provided for illustrative purposes and describes an exemplary embodiment of the system in accordance with the present invention. While FIG. 1 depicts the system being utilized across a WAN by multiple users on a variety of computing devices, it would be apparent to one of ordinary skill in the art that embodiments of the present invention could be used with any number of computing devices and networks. Furthermore, one of ordinary skill in the art would appreciate that embodiments of the present invention could be utilized on a single computing device, without the need for any network or other communications system.

According to an embodiment of the present invention, the data points to be received and stored are acquired from a business via one or more methods. In an exemplary embodiment of the present invention, the data points are acquired from the businesses via one or more adaptive questionnaires presented to one or more users associated with the business. An adaptive questionnaire is comprised of a non-static set of questions where questions are selected based, at least in part, on previous responses received from a user. In this manner, a response given by a user to a presented question will be processed and the proceeding question will be determined, at least in part, by the answer given to the presented question. Each answer may be processed individually or in combination with one or more other questions answered by the user. Additionally, irrelevant or duplicate questions may be used to keep a particular user from attempting to enter responses that may dictate a particular outcome. Adaptive questionnaires are well suited for identifying and evaluating “soft variables” as they can be used to react to an individual's responses, creating an appropriate pathway for evaluating nuances in the characteristics of a business.

According to an embodiment of the present invention, an adaptive questionnaire may be comprised of a non-static set of questions tailored in a variety of fashions. Examples of tailoring of an adaptive questionnaire include, but are not limited to, tailoring a questionnaire for a specific business type, tailoring a questionnaire for a specific industry, tailoring a questionnaire for a specific transaction or alliance type, tailoring a questionnaire for a specific product or service type, tailoring for a specific corporate culture type, tailoring for a specific risk strategy. In this embodiment, the adaptive questionnaire may more directly target transactions or alliances that are of a particular importance to the businesses involved. This direct targeting may provide a higher level of accuracy in the prediction of success of any given transaction or alliance. One of ordinary skill in the art would appreciate that an adaptive questionnaire may be tailored in numerous methods, and embodiments of the present invention are contemplated for use with any method of tailoring adaptive questionnaires.

According to an embodiment of the present invention, data points may be received and stored in response to directed questionnaires. A directed questionnaire is comprised of a static set of questions typically designed to extract predefined data points from a user. For example, a form may be presented to a user that asks for the business to provide standard objective or subjective information, such as company name and address, financial information, number of employees, customer segment, goods and services provided, value activities and corporate structure. In this manner, standard information may be received and stored in a simple, straight forward fashion, and this standard information may be utilized by the system and methods of the present invention to both assist in producing meaningful results as well as providing a basis for comparison against information provided in the aforementioned adaptive questionnaires.

According to an embodiment of the present invention, a directed questionnaire may be comprised of a static set of questions tailored in a variety of fashions. Examples of tailoring of a directed questionnaire include, but are not limited to, tailoring a questionnaire for a specific business type, tailoring a questionnaire for a specific industry, tailoring a questionnaire for a specific transaction or alliance type, tailoring a questionnaire for a specific product or service type. In this embodiment, the directed questionnaire may more directly target transactions or alliances that are of a particular importance to the businesses involved. This direct targeting may provide a higher level of accuracy in the prediction of success of any given transaction or alliance. One of ordinary skill in the art would appreciate that a directed questionnaire may be tailored in numerous methods, and embodiments of the present invention are contemplated for use with any method of tailoring directed questionnaires.

It is important to note that, unlike systems currently used in the art, the questionnaires utilized in the systems and methods herein described are comprised of questions pertaining to the business itself, not simply about potential transactional targets. Current systems focus on identifying characteristics of targets a business may be interested in (e.g., what size company are you looking to transact with?, In what industry are you looking?) By focusing on the business itself, the system and methods of the present invention are capable of identifying potential transaction candidates that have a higher chance for success. Additionally, by focusing on the business, the system and methods of the present invention are capable of steering a business away from transactions that would likely result in failure, even where the business believes such a transaction meets the criteria it has internally identified.

The systems and methods of the present invention may utilize questionnaires that ask about the potential targets for transactions a business has envisioned. However, these questionnaires are typically used in conjunction with questionnaires that ask questions about the business itself in order to build a better profile of the business.

Data points may also be determined and produced by the systems and methods of the present invention. For instance, as a business uses the systems and methods herein presented over time, the system begins to learn from successful and unsuccessful determinations. For example, if the system and methods herein presented predicts or determines a successful strategic alliance between two or more businesses, the data points used to make the determination may be weighted positively. In this manner, positively weighted data points may be used with additional confidence in future determinations. Conversely, data points used to make a prediction or determination that result in a failed transaction may be negatively weighted and used with less confidence in future determinations.

By accumulating and weighting data points from numerous businesses in this manner, embodiments of the present invention are capable of predicting synergistic alliances that may maximize growth and productivity. According to an embodiment of the present invention, weighting algorithms are applied to a plurality of accumulated data points to determine sets of objective and subjective data points compatible between two or more businesses. One of ordinary skill in the art would appreciate that sets of compatible data points does not necessarily mean that the data points are equivalent. In many cases, compatible sets of data points include objective and/or subjective data points that are comprised of inverse, opposite or substantially dissimilar values. For example, companies that have substantially opposite data points in terms of debt-ratios may still be positively weighted for a successful transaction due to potential benefits related to tax implications.

According to an embodiment of the present invention, probabilities of a match are determined based on an analysis of the data points as a whole or some portion thereof. Each data point may have an “importance score/rating” value. These importance score/rating values help determine the importance of an individual data point in relation to the other data points. Each data point is assigned a score depending on how it interacts with other variables to determine which matches are appropriate and have the potential to consummate a transaction.

According to an embodiment of the present invention, after the data from a particular company or business is uploaded into the system of the present invention and analyzed using a unique set of algorithms and matching technologies, the resulting data is compared to data from other companies and the automation software of the present invention, narrows down the range of possible matches to achieve the best possible fit for the particular company with one or more other companies or transaction types. The system may generate a list of companies or transaction types and neat organize them in order of priority defined by transaction attractiveness or any other desired ordering factor. At this point, the findings may be reviewed to identify which of the listed candidate companies or transaction types are most attractive from a transaction perspective for the transaction seeking company.

According to an embodiment of the present invention, the systems and methods herein may provide proactive profiling and automated analysis of potential transactions. In this manner, a business that has already entered all the necessary data points into the system may be provided with real-time or near real-time alerts regarding potentially beneficial transactions. Instead of a company actively searching for potential transactions, which requires the use of resources and sub-optimal searching techniques, the current system allows for automation of the search and analysis portion of the transaction identification process. Current search techniques only reveal the transactions currently profiled and available at the time of search. The systems and methods herein provided allow for proactive profiling in real-time, allowing for new transactions to be presented to a business or company as soon as they become available.

According to an embodiment of the present invention, one or more data points related to one or more businesses may be constantly updated in real-time or near real-time. Advantageously, this allows for continuous adaptation of the analysis of potential transactions in real-time or near real-time. For instance, an Application Program Interface (API) may be utilized by the system, allowing a business's financial data (e.g., stock price, cash on hand, P/E ratios) to be streamed into a computing device related to the system in real-time or near real-time. The changes in the data points received by the API may cause a potential transaction to be identified and cause an alert to be sent to an interested business. Since transactions of the type discussed in the present application may be extremely time sensitive, having real-time or near real-time alerts and transaction analysis is extremely advantageous to businesses and companies.

A significant feature of the present invention that maximizes its deal making capacity lies in the two types of matchmaking systems used in making transaction recommendations for a company. These two matching systems are, deterministic matching and probabilistic matching. One of ordinary skill in the art would appreciate that the use of these two matching systems are not necessarily mutually exclusive. Either one or both of these two matching systems may be utilized in order to identify the most beneficial transaction a particular business could pursue.

Deterministic matching involves recommending mergers and acquisitions or other business development activity based on detailed input provided by a company. As previously noted, the detailed input from a company may be achieved through the use of one or more adaptive questionnaires, one or more direct questionnaires or any combination thereof. The system of the invention actively solicits transaction related information from companies based on its proprietary categorization scheme which directly matches companies within an industry based upon this input.

According to an embodiment of the present invention, probabilistic matching may involve making transaction recommendations based on a transaction strategy that utilizes specific algorithms in evaluating matching candidates for a company within a company database. For probabilistic matches, the inventions' recommendation engine may rank transactions by likelihood of success and provide a transaction rationale for each business development opportunity. Furthermore, the invention's recommendation engine may determine fair value ranges for a given transaction to assist a company in the negotiation process.

Another significant feature unique to the present invention as it relates to probabilistic matching is the ability of its unique software to tease out and analyze past transaction patterns, and historical, non-obvious alliances to determine which companies are capable of consummating which transactions. As noted above, positively and negatively weighted data points related to the past transactions of a business or company, as determined by the software over time, may be utilized to predict transactions of this nature. This is in essence true probabilistic matching and artificial intelligence, not purely based on the questionnaires posed, but rather on patterns gleaned from previous and old transactions by the system of the present invention to suggest transactions between companies based on the programmed transaction patterns. The past transaction patterns may also be gleamed from transactions occurring outside of the system. Data points related to historical transactions could be entered and used in modeling future transactions processed by the system.

According to an embodiment of the present invention, the probabilistic matching software may be comprised of modules allowing for variable weighting of particular transactions or transaction types. Since the success of a particular transaction in the past may be related to one or more specifics of that period in time, modules of the probabilistic matching software allow administrators or developers to adjust weighting mechanisms to reflect currently important factors and deprecate factors that are no longer relevant in the transaction process. Advantageously, these modules allow for the systems and methods of the present invention to remain current in the rapidly changing world of transactions and strategic alliances.

According to an embodiment of the present invention, the probabilistic matching software may be comprised of one or more monitoring modules that monitor the variables related to a particular potential transaction during the negotiation of the potential transaction. The monitoring modules may alert a company or business if at any time before the finalization of the transaction, the transaction becomes undesirable or if a transaction with a higher potential for success arises.

According to an embodiment of the present invention, probabilistic matching may occur through the utilization of specialized adaptive questionnaires. In this embodiment, a user may be provided with an evolving set of questions based in part on each response received from the user. Each iteration of questions presented to the user serves to guide and inform a user about one or more transaction types or potential transaction targets. Utilized in this manner, the systems of the present invention does not wait until all data points are received before identifying appropriate transaction types or potential transaction targets. Instead, the system of the present invention may perform analysis and prediction at each step along the way.

An example of probabilistic matching occurring through the utilization of specialized adaptive questionnaires is as follows. A business with a strong brand may interact with the system in order to determine a potentially beneficial transaction or transaction type. The business is unaware of any particularly beneficial transaction or transaction type available to it prior to utilizing the system. The system begins by asking a series of questions to identify pertinent information about the business. Through a series of questions, it is determined that the business is in the business of producing tangible goods. The system then asks questions to the business about the brand strength of the business's tangible goods (e.g., is at least one of your tangible goods in the top 5 in terms of brand recognition?). Through responses to these brand strength questions, the system determines there is a strong brand identity in at least one of the business's tangible goods. The system then asks questions related to the ability of the business to license the strongly branded tangible goods. Through responses to these questions, the system determines that the business may be able to benefit from a strategic alliance based upon the licensing of their brand recognition. The system then may present potentially beneficial transaction targets or continue to question the business user about other potentially important data points (e.g., is retaining control over your brand more important than increasing revenue by utilizing your brand in a different market?).

Through the questioning and responding to the questions about the business in the manner presented in the previous example, two important elements are occurring. First, the business is being presented questions formatted in such a manner that the business is being lead into lines of thinking that were not obvious or apparent to the business. For instance, after determining that the business had a strong brand, the system, by asking about the ability to license the brand, is leading the business to begin to think about licensing their brand as a potential future realm of opportunity. The second element is that the system is learning more about the business with each iteration of questions. At the end of the process, the system has effectively led the business through the entire process of identifying one or more appropriate transactions the business may benefit from.

According to an embodiment of the present invention, probabilistic matching through specialized adaptive questionnaires may be further enhanced by presenting questions related to specific deals during the questioning portion of the process herein described. For instance, a business may be presented with a transaction or transaction type in the form of a question (e.g. have you ever considered a strategic alliance with Acme Corp?). In this manner, the probabilistic matching techniques provided herein may be enhanced by presenting potential transactions and transaction types prior to the completion of the adaptive questionnaire process. Additionally, responses to questions regarding specific transactions or transaction types may be used to ascertain specific information about the business, and responses to these questions may be used to weight the values of numerous related data points or guide the future iterations of questions (e.g., is your decision not to pursue a strategic alliance with Acme Corp based in part on the corporate culture of Acme Corp?).

In another embodiment of the present invention, transaction making may be accomplished through intermediaries such as investment banks, business brokers and consultants. In this embodiment, leads generated through data analysis by the system may be sold to these intermediaries for a small fee charged per lead. In some cases the system of the present invention will choose to mandate a percentage of the success fee should the intermediary successfully broker the transaction. A related embodiment, envisions a network of intermediaries who will be charged with assisting in the facilitation of deals in exchange for a percentage of transaction value. This will set in place a hierarchy of “vendor managers” and subordinate players in the transaction making arena.

An example of the usefulness of system in accordance with an embodiment of the present invention is as follows. A generic drug manufacturer from the United Kingdom may wish to penetrate the United States generic drug market but is unaware of how to accomplish this or the best way to do so. Potential ways for penetrating the United States generic drug market include, but are not limited to, forming an alliance with a United States based generic drug manufacturer, forming an alliance with a United States based branded drug manufacturer looking to enter into the generic drug space, start a joint venture with another foreign pharmaceutical company that already has penetration into the United States generic drug market and acquiring a United States based generic drug manufacturer. Making the right choice is complicated as there are numerous options, all of which involve major transactions. The system of the present invention may assess the needs and goals of the United Kingdom based generic drug manufacturer through the use of one or more directed and/or adaptive questionnaires. Once the necessary data points are accumulated and weighted, the system may identify the best type of transaction, based on, for instance, historically successful transactions with similar data points. Additionally, the system may identify potential targets for the transaction and rank them based on the numerous synergies that exist in the data.

Alternatively, utilizing the example above, the business may be lead through the determination of a transaction or transaction type through the use of specialized adaptive questionnaires. Instead of receiving all pertinent information, assessing the information and then presenting information about potential transaction and transaction types to the user, the system may lead the business through a series of specialized adaptive questionnaires that narrow down the potential transaction or transaction type with each iteration. For example, following from the example previously presented, the UK generic drug manufacturer may be presented the following line of questions and respond in the following manner:
System: What are your transactional needs?
Business: Entrance into the foreign generic drug market.
System: What foreign generic drug market?
Business: the United States of America.
System: What transaction type would work best for your organization—joint venture, merger, acquisition, strategic alliance?
Business: Strategic alliance.
System: What form of alliance would be most beneficial to your organization—an alliance with a US generic drug manufacturer, an alliance with a foreign generic drug manufacturer with US market penetration?
Business: Alliance with a US generic drug manufacturer.
System:—presents a list of potential transactions with transaction rationales.

In this example, the business has the goal of entering the US generic drug market, but may not know how to go about doing so. Through the series of questions presented by the specialized adaptive questionnaires, the business learns about the various ways it can achieve its goal and the best way to do so. Additionally, although not shown in the prior example, each point where there is a decision to be made, additional information may be provided to the user regarding the decision. For example, the user may be presented with information pertaining to the advantages and/or disadvantages of making a particular decision.

Another complication solved by the systems and methods herein described is the situation where a business may be unaware of transactions that would be beneficial to it. These non-obvious transactions may be comprised of transactions that the business had limited or no knowledge of prior to entering data into the system. By entering data into the system, a list of potential transaction types and targets may be presented to the business user for further evaluation or consideration. In this manner, companies may be proactive with their transaction methods, creating the potential for opportunistic transactions to occur.

The technical systems and tactical methodologies used in the various embodiments of the current invention will enable a multitude of companies to conduct business development transactions that heretofore were not possible. For every one transaction utilizing the current methodology, at least three transactions could be generated using the unique capabilities and resources of the present invention. Strategic exit planning is also another goal of the present invention.

### Exemplary Embodiments

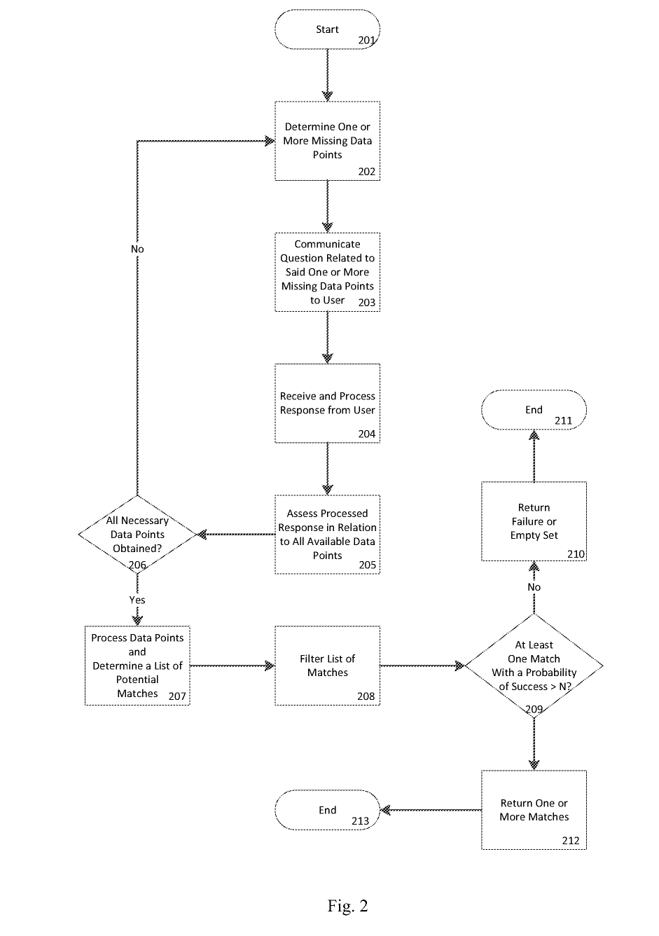

Referring to FIG. 2, an exemplary method of utilizing an adaptive questionnaire is presented in accordance with embodiments of the present invention. At the start 201, a business user begins to use the system.

In the first step 202, the system determines what data the business user has entered and if more data points are required to complete the data required to properly analyze transactions on its behalf. Optionally, if the business user has previously never utilized the system, the system may first decide to present the business uses a directed questionnaire comprised of questions related to the specifics of the business user's business (not shown).

In the second step 203, the system transmits one or more questions related to the missing data points to the business user. The questions may or may not be straight forward and/or leading and may pertain to either subjective or objective information. In this fashion, a business user may or may not explicitly know what the purpose of a particular question is. By utilizing questions that are not leading or straight forward, the system is able to gleam from the business user answers that are more honest. Additionally, more than one question may be asked per given data point in order to assess the business user's dedication to an answer. Furthermore, the questions utilized may allow for one or more style of answering (e.g., true/false, multiple choice, ratings). By utilizing many different question styles and duplicative questioning, the accuracy and weight of each data point may be fine tuned.

In the third step 204, the system receives the business user's response to the one or more questions presented and processes the response(s) based on numerous criteria previously discussed. Missing data points are updated and other data points may be adjusted in reaction to the business user's response.

In the fourth step 205, the system assesses the newly updated data. At this point, the system may check to see if it is capable of analyzing one or more transactions and transaction types based on the data. The data is comprehensively evaluated and reactions to the newly entered data points is performed.

The fifth step 206 is a determination by the system as to whether the system has enough data on the business to provide meaningful results to the business user. If it is determined that the system is still lacking important data points, the system returns to step 202 to begin the process of questioning the business user for additional data again.

If the system determines that it has enough data to provide meaningful results to the business user, the system proceeds to step 207 and begins to analyze the data against stored data related to potential applicable transactions. At the end of this process, the system produces a list of potential matching transactions.

At step 208, the system filters the list of potential matching transactions in one or more ways. Potential matching transactions may be filtered solely by the system, solely by the business user's desired filters or any combination thereof. Filters may include the filtering along the basis of one or more objective or subjective data point matches. For instance, the system may filter potential matching transactions by probability of success, transaction size, particular transaction advantage (e.g., tax implications), probability of synergistic corporate cultures. One of ordinary skill in the art would appreciate that any number of filters could be used with embodiments of the present invention, and embodiments of the present invention are contemplated for use with any number of filters.

Once the filters have been applied, The system may determine an associated probability of success for each potential matching transaction. If the probability for success of a given potential matching transaction is not at least N, where N is a percentage of perceived chance of success of the transaction, the transaction is removed from the result set of potential matching transactions. N may be set to any percentage. For example, more risk adverse businesses may choose a higher N. Alternatively, the N may be set by the system in response to available data points related to the business.

At step 209 a determination is made whether to return a failure event or empty set of potential transactions to the user of the system (step 210) or return a set of one or more potential matching transactions to the user of the system (step 212).

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A method for identifying transactions for a business, said method comprising:
determining a set of one or more data points without values,
displaying a set of one or more questions to a user,
wherein said set of one or more questions is intended to ascertain values for one or more data points about said user's business;
receiving a response to said set of one or more questions from said user;
creating a set of valued data points from said set of one or more data points without values based at least in part on said response to said set of one or more questions;
determining a business profile based on said set of valued data points;
determining one or more potential transactions based upon said business profile; and
communicating, to said user, information related to said one or more potential transactions.

2. The method of claim 1, further comprising the steps of:
determining a second set of one or more data points without values;
displaying to said user a second set of one or more questions,
wherein said second set of one or more questions is at least partially determined from said response from said user;
receiving a second response to said second set of one or more questions from said user;
creating a second set of valued data points from said second set of one or more data points without values based on said second response; and
updating said business profile with said second set of valued data points.

3. The method of claim 1, wherein said data points are comprised of objective information.

4. The method of claim 1, wherein said data points are comprised of subjective information.

5. The method of claim 1, wherein said set of one or more questions is determined utilizing probabilistic matching techniques.

6. The method of claim 1, wherein said set of one or more questions is determined utilizing deterministic matching techniques.

7. The method of claim 1, wherein said determination of said one or more potential transactions utilizes historical transaction data.

8. The method of claim 1, wherein said set of valued data points is comprised of one or more data points with weighted values.

9. The method of claim 1, wherein said information is comprised of one or more transaction rationales for each of said one or more potentially beneficial transactions.

10. A method for identifying beneficial transaction types, said method comprising:
determining a set of one or more data points without values,
displaying a first set of one or more questions to a user,
wherein said first set of one or more questions is intended to ascertain values for one or more data points about said user's business;
receiving a response to said first set of one or more questions from said user;
creating a set of valued data points from said set of one or more data points without values based at least in part on said response to said first set of one or more questions;
determining one or more potentially beneficial transaction types based at least in part on said responses to said set of valued data points;
determining a second set of one or more questions, wherein said second set of one or more questions is intended to lead said user towards selecting one of said one or more potentially beneficial transaction types;
displaying said second set of one or more questions to user.

11. The method of claim 10, wherein said data points are comprised of objective information.

12. The method of claim 10, wherein said data points are comprised of subjective information.

13. The method of claim 10, wherein said set first set of one or more questions is determined utilizing probabilistic matching techniques.

14. The method of claim 10, wherein said first set of one or more questions is determined utilizing deterministic matching techniques.

15. The method of claim 10, wherein said determination of said one or more potentially beneficial transaction types utilizes historical transaction data.

16. The method of claim 10, wherein said set of valued data points is comprised of one or more data points with weighted values.

17. The method of claim 10, wherein said information is comprised of one or more transaction type rationales for each of said one or more potentially beneficial transaction types.
